(19) United States
(12) Patent Application Publication
(10) Pub. No.: US 2022/0335503 A1
(43) Pub. Date: Oct. 20, 2022

(54) SYSTEM FOR FACILITATING COOPERATIVE COMMERCIAL TRANSACTIONS INVOLVING MULTIPLE PARTIES

(71) Applicant: Target Brands, Inc., Minneapolis, MN (US)

(72) Inventors: Roberto DeVet, Minneapolis, MN (US); Toni Ghilani, Minneapolis, MN (US); Anjolika Bhadra-Dave, Minneapolis, MN (US)

(21) Appl. No.: 17/719,989

(22) Filed: Apr. 13, 2022

Related U.S. Application Data
(60) Provisional application No. 63/175,914, filed on Apr. 16, 2021.

(51) Int. Cl. G06Q 30/06; G06Q 10/08; G06Q 20/10; H04L 67/306

(52) U.S. Cl. CPC G06Q 30/0633; G06Q 10/087; G06Q 20/10; G06Q 30/0641; H04L 67/306

(57) ABSTRACT

A network based order fulfillment system having an improved user interface at devices associated with multiple customers collaborating to place and pick up an order with a retailer. The system allows users of multiple devices to coordinate generation and fulfillment of an order through communication with one or more computing devices associated with a merchant to fulfill orders placed by users of other user devices. A first user that has an account with a retailer or a service associated with multiple retailers can use a computing device to invite others to join a shopping group. Once added to the shopping group, group members can participate in various aspects of creating an order, placing the order, fulfilling the order, and other activities associated with the order. A shopping group initiator can specify various limitations on what actions each group member can perform with respect to one or more orders.

### CROSS-REFERENCE TO RELATED APPLICATIONS

This application claims the benefit of U.S. Patent Application Ser. No. 63/175,914, filed on Apr. 16, 2021. The disclosure of the prior application is considered part of (and is incorporated by reference in) the disclosure of this application.

### TECHNICAL FIELD

This document generally relates to architecture of computer systems, communications between computing devices, graphic user interfaces for eliciting user input, and updating of graphic user interfaces based on input received at other computing devices.

### BACKGROUND

Computing devices are devices that accept data input, process the data, and provide data output using hardware and software. Computing devices can communicate with other computing devices using wired or wireless networks or a combination thereof. For example, computing devices can communicate over the Internet. User interactions with a computing device can cause the computing device to transmit communications to a second computing device, which can cause the second computing device to provide output such as changes to a visual display, sounds, or tactile output. Such output at the second computing device can elicit user input from a user of the second computing device which can in turn cause the second computing device to transmit one or more communications to the first computing device and/or additional computing devices thereby causing the first computing device and/or or the additional computing devices to generate additional output.

### SUMMARY

This document generally describes a network based commerce and order fulfillment system that provides information to one or more user devices that allow users of multiple user devices to coordinate various aspects of assembling, completing, and fulfilling an order through communication between the user devices and, in comes implementations, communication with one or more user devices located at a fulfillment location (such as a physical store location, a restaurant, a warehouse, or other location) to fulfill orders placed by users of other user devices. For example, a first user that has an account with a retailer or a service associated with multiple retailers can use a computing device to invite others to join a shopping group (sometimes referred to as a shopping circle, a shopping family, or a shopping team). The shopping group can be associated with a specific virtual shopping cart (e.g., a single online order) or can be a permanent or semi-permanent group that can be associated with multiple virtual shopping carts/orders over time. Once added to the shopping group (e.g., by accepting an invitation initiated by the first user) the group members can participate in various aspects of creating an order, placing the order, fulfilling the order, and other activities associated with the order. In some implementations, the first user who invites others to the shopping group is identified as a group owner or order owner and can specify various limitations on what actions each group member can perform with respect to one or more orders.

In one example implementation, an order owner can start an order by placing into a virtual shopping cart for a retailer. For example, the order owner can use a web browser of a computing device to navigate to a web site for the retailer, search for items, and add various items to a virtual shopping cart. As another example, the order owner can use a dedicated application (e.g., a mobile app) executing on her computing device to identify items to purchase and add the items to a virtual shopping cart. The order owner can create a shopping group by inviting other people to participate in the shopping experience for the order. In other words, the order owner can grant other people access to the virtual shopping cart on a full or limited basis. The order owner can use to enter identifying information for one or more other people that the order owner would to invite to join a shopping group for the order. The identifying information can be, for example, a username for the invited person that the invited person uses to log into an account associated with the retailer, an email address of the invited person, a phone number of the invited person, an ID number or code associated with the second person, or other identifying information that uniquely identifies the invited person within an order processing system associated with the retailer.

Each invited person can log in to an account associated with the retailer (e.g., by visiting the retailer's website using a browser or by using a dedicated application associated with the retailer), which can cause presentation of the invitation to each invited person. For example, an instance of the dedicated application executing on an invited person's mobile device can include a notifications page that provides notifications to the invited person, including a notification that the invited person has been invited to participate in the shopping group for the order owner. As another example a computing system associated with the retailer can send a notification to the invited person using contact information provided by the order owner or stored as part of a user profile for the invited person. For example, the computing system can send a text message or email to the invited person informing them that they have been invited to participate in a shopping group with the order owner and providing additional instructions on how to accept the invitation and participate in the cooperative shopping process.

Upon accepting the invitation, each member of the group is permitted to perform various tasks associated with the order for which the order owner has invited the group members to participate in a cooperative shopping experience. Examples of tasks that can be performed by the shopping group members for one or more orders specified by the order owner can include adding items to a shared virtual shopping cart for an order, removing items from the shared virtual shopping cart, adding payment or gift card information to pay for part or all of the order, placing the order (e.g., checking out once all desired items have been added to the shopping cart), picking up the order (e.g., curb-side, drive-up, or in-store pickup), returning items, specifying a delivery address, cancelling the order, or specifying other people to participate in the shopping group for the order. In some implementations, the order owner can specify parameters for each shopping group member that define what activities each group member is allowed to perform with respect to the order. For example, the order owner can specify that a first group member is allowed to perform all possible actions with respect to an order (e.g., all of the same actions permitted for the order owner), specify that a second group member is allowed to add items to the cart and pick up the order but not to place the order or perform other functions, and specify that a third group member is allowed to add only up to $30 worth of items to the shared virtual shopping cart.

The order owner can also specify what information can be viewed or received by each member of the shopping group. For example, the order owner can specify that one or more other group members can see all items in the virtual shopping cart or only items that they themselves added to the virtual shopping cart. As another example, the order owner may specify that other group members are restricted from viewing payment or gift card information associated with the order, or can specify that each group member can see limited information regarding payment or gift card options (e.g., a group member can see a payment option of “Jan's Red Credit Card” without seeing the credit card number or other information). Other information that group members can be restricted from viewing, by the order owner, includes fulfillment location, other fulfillment information (e.g., fulfillment type), delivery address, identifying information of other shopping group members, and order status information. The order owner can also specify if other members of the shopping group are permitted to receive notifications regarding the order (e.g., order ready for pickup, order delivery on its way, order eligible for exclusive deal, communications regarding substituted order items). The order owner can also specify how notifications are to be delivered to both the order owner and other members of the group, such as via text message, email, telephone call, or notifications in a dedicated application associated with the retailer.

In some implementations, an order owner can share various memberships, discounts, or special features with shopping group members. For example, the order owner can grant access to a gift card to shopping group members. As another example, the order owner can share a discount subscription membership, military discount status, senior discount status, employment based discount status (e.g., discount for school teachers), and loyalty reward program with other members of the shopping group. For example, if the order owner is a military member and has a military discount status with the retailer, the order owner can share this military discount with other members of the shopping group. In some instances, shared discount statuses or subscription statuses can only be shared with respect to group orders. In some instances, shared discount statuses or subscription statuses can only be shared with a limited number of persons or with persons that reside at a single or limited number of addresses. As another example, members of a shopping group can pool loyalty program reward points to allow reward points earned based on orders placed by each member of the shopping group to be pooled together to allow any of the shopping group members to redeem the shared reward points.

The various computing devices used by the shopping group members can collect user input and other information via user interfaces of the computing devices and/or one or more input sensors of the computing devices to identify items that the shopping group members have added to a shared virtual shopping cart as well as payment information and order fulfillment parameters. This information can be used to submit an order for the identified items included in the virtual shopping cart to a computing system associated with a merchant. For example, one of the group members can select an option to check out and provide payment information to submit the order to the computing system associated with the merchant. One of the group members can complete fulfillment of the order, such as by picking up the order from a fulfillment location associated with the merchant (e.g., “curb side”, “drive up” or “in-store” pickup of the order at a brick and mortar store).

A worker at a fulfillment location (e.g., a physical store) can receive information about the order on a user device to allow the worker to fulfill the order in a timely manner and provide the items in the order to one of the shopping group members that is authorized to pick up the order upon the shopping group member arriving at the fulfillment location. The worker can interact with her user device to cause the worker's device to update a status of the order and provide information to the order owner's computing device (and potentially computing devices of other shopping group members, depending on permissions specified by the order owner) to provide additional information to the order owner (and potentially other group members) regarding status of the order, changes to items included in the order, and information related to fulfillment/pick up of the order. In one aspect, the computing device of the shopping group member that is picking up the order can provide a user interface that includes a unique optically recognizable code (e.g., a barcode or a matrix barcode) that can be used to verify that the person picking up the order is authorized to pick up the order (e.g., the order owner has granted the group member order pickup permissions). The optically recognizable code can also be used to verify information associated with the order such as order number, information associated with the order owner, information associated with a payment option for the order, or information associated with the group member that is picking up the order. The store employee's computing device can provide instructions to the employee for scanning, or otherwise verifying, the optically recognizable code. The employee can then use her device to scan the optically recognizable code displayed by the shopping group member's device to verify that the shopping group member is authorized to pick up the order, such as by verifying the shopping group member's identity or an aspect of the order. In some implementations, the employees computing device can display identifying information for the group member upon scanning of the optically readable code (such as the group member's first and last name) that can be compared to identification carried by the shopping group member (e.g., a driver's license) to verify the shopping group member's identity at the time of pickup.

In some aspects, the order owner uses a computing device to initiate communication an invitation to a second user to become a shopping partner associated with a specific order initiated by the order owner, a group of orders specified by the order owner, or all orders placed by the order owner. For example, the order owner can cause a computing system associated with a retailer to transmit a text message (e.g., an SMS message or instant message) to the second user's device inviting the second user to become a shopping partner with the order owner. The text message can include, for example, a user selectable link that, when selected by the second user grants the second user access to one or more shared virtual shopping carts specified by the order owner. In some cases, the second user can be granted permission to access and interact with a specific order designated by the order owner, all orders placed by the order owner during a set time period, all orders placed by the order owner until the order owner rescinds permission, or a set of orders designated by the order owner. As another example, the order owner can use a computing device to initiate transmission of an email message from a computing system associated with the retailer to an email account of the second user. The second user can access the email on the second user's device to receive authorization participate in the shared shopping experience by joining a shopping group with the order owner. The email can include, for example, a user selectable link that, when selected by the second user grants the second user permission to interact with one or more orders started and/or placed by the order owner. As yet another example, the message inviting the second user to join a shopping group can be initiated via a proprietary application. For example, the order owner and/or the second user can have a dedicated application associated with the merchant on their respective devices. The order owner can use the application installed on his device to initiate transmission of a message to the second user inviting the second user to join a shopping group. The second user can log into a version of the application installed on her device to view information associated with one or more orders identified by the order owner or additional information associated with the shopping group in general. The application installed on the second user's device can also display a scanable code that can be used to verify that the second user is authorized to pick up a shared order placed by the shopping group.

In another aspect, information collected at the second user's device (e.g., from user input or via a location detection unit such as a GPS unit of the user's device) can be transmitted to the worker's device to cause the worker's device to provide an indication that the second user has begun to travel to the fulfillment location. The worker's device can also display an estimated arrival time or estimated time until arrival at the fulfillment location for the second user. For example, the second user's device can determine that the second user has begun to travel to the fulfillment location. The second user's device can transmit a communication to the worker's device indicating that the second user has begun traveling to the fulfillment location. The worker's device can provide an estimated time until arrival at the fulfillment location for the second user. Upon the second user arriving at or near the fulfillment location, the second user's device can transmit a communication to the worker's device indicating that the user has arrived. In some implementations, this can cause the worker's device to display a count up timer indicating how long the second user has been waiting for the order after arriving at the fulfillment location. In some implementations, if the count up timer reaches a preset threshold, a customized notification can be provided to the order owner's device and/or the second user's device to indicate a status of the order, indicate additional instructions for the second user, or communicate another message to the first or second user.

In another aspect, a user interface provided at a computing device of one of the shopping group members (including the order owner) can provide one or more controls for altering aspects of an order after the order has been placed. For example, the user interface can allow the group member to add additional items to the order, remove items from the order, or add additional shopping group members (e.g., a new shopping group member authorized to pick up the order or return items for the order). As another example, the user interface can allow the group member to indicate substitute items for items from the original order that are not available. As another example, the user interface can allow the group member to switch the order type from a drive-up type order to an in-store pick up order. As another example, the user interface can allow the order owner to remove people from the shopping group. For example, the order owner can remove the second user from the list of authorized pickup persons, after having previous designating the second user as an authorized pickup person.

In one aspect, in general, a method includes receiving, by at one or more computing devices and from a first computing device, identifying information for an account associated with a first user and identifying information for a second user, wherein the identifying information for the account associated with the second user is provided by the first user via a user interface of the first computing device; transmitting, by the one or more computing devices and in response to receiving the identifying information for the second user, a notification to the second user indicating that the second user has been invited to join a shopping group initiated by the first user; receiving, by the one or more computing devices and from a second computing device, a communication indicating acceptance, by the second user, of the invitation to join the shopping group initiated by the first user; receiving, by the one or more computing devices, information indicating specific permissions for the second user with respect to the shopping group, the information indicating specific permissions for the second user having been provided by the first user; associating an identifier for the second user with an electronic record for the shopping group; associating at least one of the specific permissions with the identifier for the second user within the electronic record for the shopping group; receiving, by the one or more computing devices and from the first computing device, an indication of a first item to add to a virtual shopping cart associated with the shopping group; receiving, by the one or more computing devices and from the second computing device, an indication of a second item to add to the virtual shopping cart; and transmitting information on an order placed in association with the virtual shopping cart for the shopping group to a computing device at a fulfillment location associated with a merchant.

In some aspects, associating an identifier for the second user with the electronic record for the shopping group includes using the identifying information for the second user provided by the first user to identify a profile for the second user, the profile being a profile associated with the merchant; retrieving a unique identifier for the second user from the profile for the second user; and entering the unique identifier for the second user into a group member field within the electronic record for the shopping group.

In some aspects, the method further includes receiving, from the first computing device, information indicating that the second user is permitted to pick up orders associated with the shopping group. Aspects of the method may further include in response to receiving the information indicating that the second user is permitted to pick up orders associated with the shopping group, associating a permission to pick up orders with the unique identifier for the second user within the electronic record for the shopping group. Aspects of the method may further include associating information for a first payment method provided by the first user with the shopping group. Information for a second payment method provided by the second user can be associated with the shopping group. An indication to split the payment for the order placed in association with the virtual shopping cart can be received. A first portion of the amount for the order can be charged to the first payment method. A second portion of the amount for the order can be charged to the second payment method.

In some aspects, the first user can be logged into an account for the merchant on the first computing device and the second user is logged into an account for the merchant on the second computing device. The information indicating specific permissions for the second user with respect to the shopping group can include an indication of a spending limit for the second user.

In some aspects, the method further includes, responsive to receiving the indication of the second item to add to the virtual shopping cart, confirming that addition of the second item to the virtual shopping cart will not cause the second user to exceed the spending limit. The second item can be added to the virtual shopping cart responsive to confirming that addition of the second item to the virtual shopping cart will not cause the second user to exceed the spending limit. Responsive to receiving the indication of the second item to add to the virtual shopping cart, it can be determined that addition of the second item to the virtual shopping cart will exceed the spending limit for the second user. Addition of the second item to the virtual shopping cart can be rejected responsive to determining that addition of the second item to the virtual shopping cart will exceed the spending limit for the second user.

The systems, devices, program products, and processes described throughout this document can, in some instances, provide one or more of the following advantages. By providing streamlined communications between mobile devices operated by users/customers (including multiple shopping group members) and employees working at fulfillment locations, an order fulfillment system can reduce the amount of time spent interacting with the mobile devices, thereby reducing power consumption and improving battery life of the computing devices. Additionally, by streamlining communications while providing for computer network based ordering and pick-up facilitation, the computing system can reduce the amount of communications to and from mobile computing devices, thereby reducing bandwidth usage of one or more communications networks and freeing up communications bandwidth for other purposes. Additionally, unique user interface elements at mobile computing devices of each member of a shopping group and employees of fulfillment locations associated with one or more shared shopping carts can improve user experience thereby leading to improved outcomes with respect to efficiency and accuracy of both user interactions with the mobile computing devices and fulfillment of orders. Other benefits and advantages will be apparent from the following descriptions.

### DESCRIPTION OF DRAWINGS

FIG. 1 is diagram of an example system for facilitating formation of shopping groups and collaborative shopping.

FIGS. 2A-2D show example user interface displays for a first computing device of a shopping group initiator in collaborative shopping group order fulfillment system.

FIGS. 3A-3B show example user interface displays for a second computing device for an invited shopping group member in collaborative shopping group order fulfillment system.

FIGS. 4A-4B show example user interface displays for collaboratively shopping in association with a shopping group.

FIGS. 5A-5D show example user interface displays fulfilling a pick up collaborative shopping order.

FIG. 6 is a flowchart of an example process to be performed by a computing device in an collaborative shopping group order fulfillment system.

FIG. 7 is a schematic diagram that shows an example of a computing system.

Like reference symbols in the various drawings indicate like elements.

### DETAILED DESCRIPTION

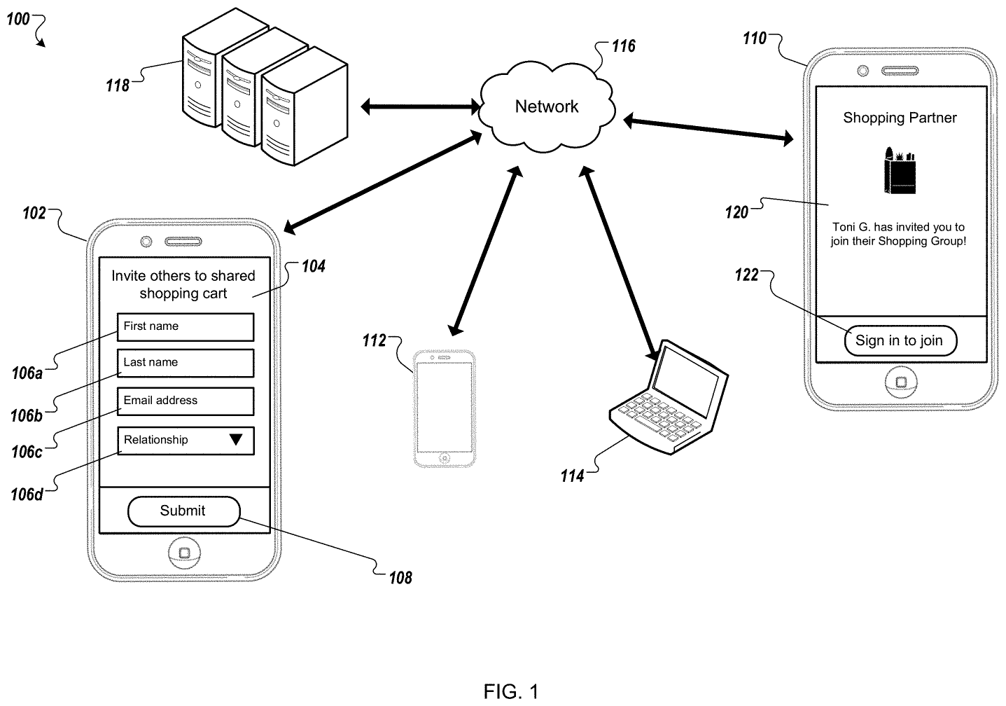

FIG. 1 is a diagram of an example system 100 for facilitating generation, placement, and fulfillment of orders among multiple user organized as a shopping group with respect to a particular retailer. A shopping group (sometimes referred to as a shopping family, shopping circle, or simply a group, family, or circle) can be a group of people who share access to one or more shared shopping carts and/or who share other aspects of online order placement and fulfillment. In some implementations, members of a shopping group In the system 100, a first user, such as a customer who wishes to form a shopping group for placing an online order for items from a merchant, can access a dedicated application executing on a mobile device 102. The mobile device 102 can be, for example, a mobile phone, a tablet device, a touch screen computer, a laptop computer, a PDA, a smart watch, or other mobile device. In some implementations, a non-mobile computing device, such as a desktop computer or smart television, performs the functions described with respect to the mobile device 102 and therefore all descriptions related to use of a mobile device apply equally to non-mobile computing device. In some implementations, instead of accessing a dedicated application executing on the mobile device 102, the first user can use a browser of the mobile device 102 to access a website that provides the below described functionality and therefore all descriptions related to use of the dedicated application apply equally to a web-based implementation. The first user can sometimes be referred to as an order owner or an order initiator. In some implementations, the first user may initiate formation of a shopping group but may not be the owner or initiator of all orders placed by or associated with the shopping group.

The first user logs into the dedicated application by entering a user name or other identifier and a password. Alternatively, the first user can log into the dedicated application by providing biometric information using one or more sensors of the mobile device 102 such as by scanning a fingerprint using a fingerprint scanner of the mobile device 102 or using a retina scanner of the mobile device 102 to scan the first user's retina information. In some implementations, the first user may be already logged into the dedicated application from a previous session.

The first user can use the dedicated application to initiate an order by selecting items for purchase from a store using an online shopping interface. For example, the dedicated application can be a grocery shopping application that can permit the first user to search and/or browse for grocery items, add desired items to a virtual shopping cart, and place an order for the selected items by entering payment information. The first user can also use the dedicated application to access one or more previously entered orders. For example, the first user may have previously logged into an online account for a retailer associated with the dedicated application and placed an on-line order for one or more items using either the mobile device 102 or a different computing device such as a home or laptop computer. As another example, the first user may have previously placed an on-line order using the dedicated application. The first user can access and review the previously placed orders after logging into the dedicated application. This can include reviewing items included in the orders and additional information associated with the orders such as an estimated time until the order is ready, payment used for the order (e.g., “card ending in 123”), a fulfillment location for the order, and other information associated with the orders.

The first user can further use the dedicated application to form one or more shopping groups associated with an order that the first user has started but not yet placed, orders already placed but not yet fulfilled, or one or more future orders. For example, the first user may form a shopping group and allow members of shopping group to interact with all future orders placed by the first user unless otherwise specified by the first user. Such shopping groups in which all members of the group can access all orders initiated by other members of the group may be useful, for example, for spouses who often share shopping responsibilities.

The mobile device 102 can communicate with other computing devices through a network 116, such as, for example, the Internet. For example, the mobile device 102 can communicate with a network access point such as a WiFi router or a cellular communication tower to access the network 116 and communicate with other computing devices. For example, the mobile device 102 can communicate with a server system 118 consisting of one or more servers through the network 116 to place orders, form shopping groups, and interact with other members of the shopping group. Alternatively, or additionally, the first user can use a different computer to place orders, form shopping groups, and interact with shopping groups by logging into an account on the different computer. The different computer can then communicate through the network 116 with the server system 118. The server system 118 can be affiliated with a retailer/merchant and process the on-line orders and communications associated with one or more shopping groups received from the mobile device 102 or another computing device.

At the time of placing an order, or at a different time, such as when logging into the dedicated application, prior to placing an order, when accessing a preferences menu, or when reviewing a previously placed order, the first user of the mobile device 102 can identify one or more other people as potential shopping partners to invite the identified people to join a shopping group. The shopping group can be a shopping group for a specific order, a shopping group for multiple orders specified by the first user, or a shopping group for future orders. For example, at the time of completing an order, the mobile device 102 can present a user interface 104 that allows the first user to enter identifying information for a person to be added to a shopping group. Submission of the identifying information can initiate a process to authorize the identified person to perform tasks associated with one or more orders, as specified by the first user. For example, the first user can create an order by selecting items for the order. The dedicated application present a control that on the shopping interface that, when selected, causes the mobile device 102 to present the user interface 104 to allow the first user to designate a person to add to the shopping group for the order.

For example, the user interface 104 can include a text boxes 106a-d that the first user can use to enter a identifying information for a second user (e.g., the first user's spouse, a child of the first user, a parent of the first user, a friend of the first user, a co-worker of the first user, or another person that the first user wishes to add to the shopping group). The user interface 104 includes a field 106a for entering a first name of the second user, a field 106b for entering a last name of the second user, and a field 106c for entering an email address for the second user. The user interface 104 further includes a field 106d that allows the first user to identify a relationship with the identified invited shopping group participant (e.g., spouse, child, parent, friend, co-worker, grandchild, cousin, etc.). In some implementations, the first user is not required to specify a relationship for other invited group members. The email address entered in field 106b can be, for example, an email address that the invited shopping group participant has used to register for an account with the retailer associated with the dedicated application. In some implementations, the user interface 104 elicits more, less, or different information about the invited shopping group participant. For example, the user interface 104 can only elicit an email address or other communication identifier for the invited shopping group participant (e.g. a phone number) and does not require that the first user enter a name for the invited shopping group participant. However, entering both a name and a method of contacting the invited shopping group participant can help ensure that the correct person is invited to the shopping group (e.g., in instances where the first user mistypes the email address of the invited shopping group participant). In some implementations, the user interface 104 elicits different identifying information for the new shopping group member, in place of or in addition to the email address, such as a phone number, messaging app username, a username associated with the invited shopping group participant's account with the retailer, or another unique identifier for the new shopping group member. The identifier can be, for example, a username for the invited shopping group participant that the second person uses to log into an instance of the dedicated application.

In some implementations, the user interface 104 can include a control that allows the first user to save the information for the invited shopping group participant identified using the fields 106a-d to use for future shopping groups formed by the first user. For example, the control can cause the server system 118 to save the entered information for the invited shopping group participant in association with a profile for the first user. As another example, the server system 118 can save an identifier for a profile for the invited shopping group participant in association with the profile for the first user. When creating future shopping groups, the dedicated application can present a list of previously saved shopping group participants invited by the first user to allow the first user to select a previously designated person for inclusion in a new shopping group.

Upon entering the identifying information for the invited shopping group participant in the fields 106a-d, the first user can select a control 108 to submit the information for the invited shopping group participant to invite the identified person to join the shopping group with the first user. After submitting the information for the invited shopping group participant, the first user can invite additional people to join the shopping group by using further instances of the user interface 104 displayed by the dedicated application executing on the mobile device 102.

In some implementations, the shopping group can be used to initiate and place orders for multiple different retailers. For example, the dedicated application can allow the group members to place different online orders for fulfillment by multiple different retailers. The shopping group members can form shopping carts for various different retailers and place orders with the different retailers using the same shopping group feature.

Upon the first user submitting the identifying information for invited group members (e.g., by selecting the control 108), the mobile device 102 transmits a message through the network 116 to computing devices associated with each invited group member. For example, a second user invited to join the shopping group can have a mobile device 110, a third user invited to join the shopping group can have a mobile device 112, and a fourth user invited to join the shopping group can have a computing device 114. In some implementations, rather than direct communication with the other users' computing devices 110, 112, 114, communications inviting the other users to join the shopping group are communicated to the computing devices 110, 112, 114 indirectly via the server system 118. For example, the mobile device 102 sends one or more communications to the server system 118 that includes identifying information for the second, third, and fourth users entered by the first user via the user interface 104. The server system 118 can look up each of the second, third, and fourth users using the provided identifying information. Upon identifying the second, third, and fourth users, the server system 118 can transmit communications to each of the second, third, and fourth users inviting them to join the shopping group started by the first user. In some implementations, the server system 118 can transmit the invitations to join the shopping group using the communication information provided by the first user (e.g., the email address for each additional user provided using the field 106c).

The communications to the computing devices 110, 112, 114 can take the form of, for example, an email, a text message (e.g., SMS or instant message), or a message in an instance of the dedicated application installed on one or more of the computing devices 110, 112, 114. For example, in some cases, the identifying information for the second user entered by the first user using the user interface 104 may include an address or identifier that can be used to communicate with the second user, such as an email address, phone number, or messaging application screenname. In some implementations, the server system 118 can store or access communication information for the second user using the identifier for the second user and transmit the communication to the second user using a retrieved communication address (e.g., phone number, email address, messaging application screenname, application username) for the second user. For example, the server system 118 can use the identifier for the second user to retrieve a profile for the second user. The profile can be, for example, a profile for a particular retailer associated with the dedicated application installed on the mobile device 110. The profile can include a username or other identifying information associated with the second user and the server system 118 can use this information to transmit a communication to the mobile device 110 that can be accessed by the dedicated application executing on the mobile device 110 to convey the invitation to join the first user's shopping group to the second user. In some implementations, the server system 118 does not actively transmit communications to the computing devices 110, 112, 114 but rather passively provides the communications to the computing devices 110, 112, 114 by allowing the respective users to log in to an account on the server system 118 using the respective computing devices 110, 112, 114 (e.g., via an instance of the dedicated application executing or using a web browser) to access and confirm the invitation to join the first user's shopping group.

Going forward, this application will describe the shopping group process in more detail focusing on the second user and the mobile device 110. However, the below descriptions apply equally to additional shopping group invitees, including the third and fourth users using the mobile device 112 and computing device 114, respectively, described above.

Upon receiving the communication indicating that the second user has been invited to join the first user's shopping group, the mobile device 110 can display a user interface 120 informing the second user that they have been invited to join the shopping group initiated by the first user. For example, the mobile device 110 can provide a push notification to the second user indicating that the second user has been invited to the shopping group. The second user can then select the push notification and/or unlock the mobile device 110 to cause the mobile device 110 to display the user interface 120. For example, an instance of the dedicated application executing on the mobile device 110 can cause a push notification to be displayed on a lock screen for the mobile device 110 indicating that the second user has been invited to be a shopping partner for the first user. The second user can select the push notification which can cause the mobile device 110 to open the dedicated application and dedicated application can display the user interface 120.

As another example, the invitation to become a shopping partner with the first user can be transmitted to the mobile device 110 via text message or email. In some instances, receipt of the text message or email will cause the mobile device 110 to display a notification of the received communication. The notification may include a portion or all of the text of the communication and/or may include additional information about the communication, such as by identifying the dedicated application, the retailer, or the first user. The second user can access the received text message or email using a text messaging application, email application, web browser, or other application installed on the mobile device 110. The received text message or email may include a link that, when selected by the second user using a user interface of the mobile device 110, links to an invitation to join a shopping group with the first user with respect to one or more orders. For example, the second user can select a link displayed in a received text message to cause the mobile device 110 to display the user interface 120 in a web browser or in the dedicated application.

The user interface 120 includes a control 122 that, when selected, allows the second user to accept the invitation to join the shopping group with the first user, such as by logging into the second user's account with the retailer. If the second user does not already have an account with the retailer, the second user can select the control 122 to access a user interface that allows the second user to create an account with the retailer and then accept the invitation to join the first user's shopping group.

In some implementations, if the email address or other contact method (e.g., phone number) for the second user provided by the first user using the user interface 104 is not associated with the second user's account with the retailer, the second user can request that the first user resend the invitation using the correct contact info associated with the second user's account with the retailer. For example, many people use multiple different email addresses for different purposes, or can have multiple phone numbers (e.g., cell phone number, work number, home number). The first user may provide a first email address for the second user to invite the second user to join the first user's shopping group. However, the second user may have an existing account with the retailer under second email address. In one example, the server system 118 can, upon receiving a notification from the mobile device 102, access a database of user account profiles to determine if the invited shopping partner has an existing account with the retailer. If the contact information provided by the first user matches an account profile for an existing user, the server system 118 can send a notification to the second user using contact information stored in the second user's account profile, using the contact information provided by the first user, or by sending the second user a message within the retailer's system in association with the second user's account. For example, the server system 118 can send the second user a message that the second user can access using the instance of the dedicated application executing on the mobile device 110. In some cases, the dedicated application can send a push notification to the second user on the mobile device 110 informing the second user that they have received a notification and/or that the second user has been invited to join the shopping group of the first user.

Continuing with this example, in a situation in which the name and/or contact info provided by the first user does not match an existing account profile, the server system 118 uses the contact information provided by the first user to send a notification to the second user inviting the second user to create an account with the retailer and join the first user's shopping group. If the second user does not already have an account with the retailer, the second user can select the control 122 to create an account and accept the invitation to join the first user's shopping group. If the second user already has an existing account with the retailer (e.g., under a different email address), the second user can initiate a communication to the first user requesting that the first user send a new invitation to join the shopping group using the contact info for the second user that is associated with the second user's account with the retailer. In some implementations, the second user can send this communication separately from the server system 118 associated with the retailer. For example, the second user can send a text message to the first user through the network 116 requesting that the first user resend the invitation using the email address associated with the second user's account with the retailer.

In some implementations, the second user can initiate the communication to the first user requesting that the first user resend the invitation with updated contact information using the dedicated system of the retailer. For example, upon receiving the initial invitation to join the first user's shopping group at the mobile device 110, the second user can select the control 122 to log into their account with the retailer, such as by using the instance of the dedicated application associated with the retailer executing on the mobile device 110. Upon the second user logging in (or opening the dedicated application to which the second user is already logged in from a previous session), the mobile device 110 and server system 118 can communicate to allow the server system 118 to determine that the contact information provided by the first user for the second user does not match the contact information associated with the account for the second user. The server system 118 can then communicate with the mobile device 110 to cause the mobile device 110 to provide a user interface to the second user that can allow the second user to initiate a communication to the first user requesting that the first user resend the invitation using the correct contact info for the second user that is associated with the second user's account with the retailer. This can, for example, cause the server system 118 to transmit a communication to the mobile device 102 informing the first user that the contact info provided for the second user does not match the contact info associated with the account for the second user and requesting that the first user re-submit the invitation to the second user to join the shopping group using the contact info associated with the second user's account with the retailer

In some implementations, upon the second user accepting the invitation to join the shopping group, the mobile device 110 sends a communication to the server system 118 indicating that the second user has accepted the invitation. In some implementations, this can cause the server system 118 to transmit one or more additional communications to the mobile device 110 that include additional information associated with the order. For example, upon accepting the invitation, the server system 118 can communicate with the mobile device 110 to cause the dedicated application executing on the mobile device 110 to display one or more user interface screens that allow the second user to interact with and perform tasks associated with one or more orders associated with the shopping group, as specified by the first user. For example, the second user can add items to orders initiated by the first user, third user, and fourth user, initiate new orders for the shopping group, remove items from existing orders, add payment info for an order, place an order, share shopping lists with other members of the shopping group, edit a shopping list associated with a shopping group, add notes to items in a shopping cart, communicate with other shopping group members, share a subscription, share a discount status, pickup an order, specify delivery or pickup parameters for an order, add special instructions for an order (e.g., to be provided to the retailer along with the order), or perform other tasks associated with the order or the shopping group.

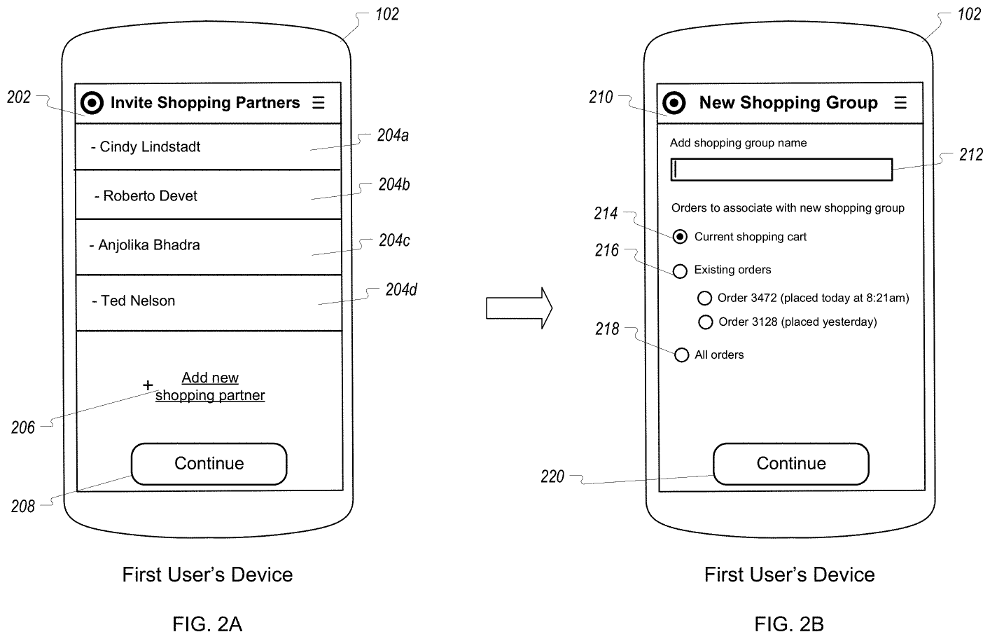

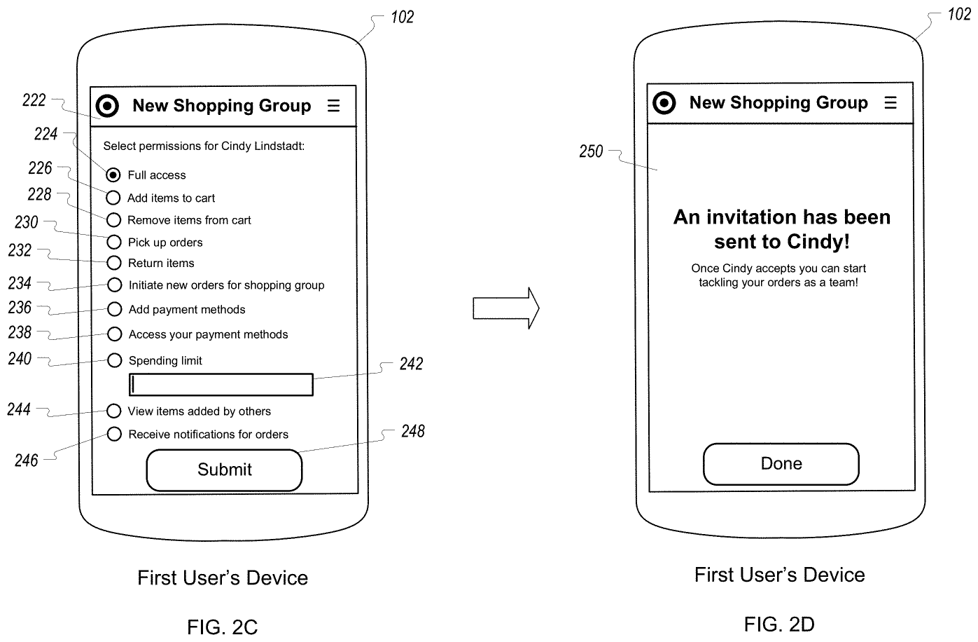

FIG. 2A shows an alternate embodiment of a user interface 202 that can be provided to allow the first user (e.g., the order initiator) to invite other people to join one or more shopping groups for one or more orders. The user interface 202 shown in FIG. 2A allows the first user can select one or more persons to invite to a shopping group. For example, the user interface 202 includes controls 204a-204d that can be selected by the first user to select previously identified shopping partners to invite to join a new shopping group. For example, the first user may have previously identified each of the people listed by the user interface 202 using the user interface 104 of FIG. 1 in association with previously formed shopping groups, existing shopping groups, or previously placed and fulfilled orders. The controls 204a-d allow the first user to identify one or more of these previous shopping group partners to join a new shopping group being formed by the first user without requiring the first user to re-enter all of the information for the person. In some implementations, the first user may select more than one of the controls 204a-d to invite multiple people to join the shopping group at the same time.

The user interface further includes a control 206 that the first user can select to invite a person not listed on the user interface 202 to the shopping group. Selection of the control 206 can, for example, cause the mobile device 102 to display the user interface 104 of FIG. 1 to allow the first user to enter information for a new shopping group member. Returning to FIG. 2A, after selecting and/or adding one or more persons to invite to the shopping group, the first user can select a control 208 to submit the selection which can cause the mobile device 102 to transmit one or more communications to initiate a process by which the identified persons are invited to join the shopping group with the first user.

Turning to FIG. 2B, selection of the control 208 from FIG. 2A can cause the mobile device 102 to display a user interface 210 that allows the first user to specify details for the shopping group, including allowing the first user to specify orders associated with a new shopping group that the first user is forming and has invited one or more other people to join using the user interface 204. For example, the user interface 210 includes a field 212 that allows the order/group initiator (the first user) to specify a name for the shopping group (e.g., “Tom and Kids,” “Office Party,” “Mom & Dad”, or “Thompson Family”).

The user interface 210 further includes user selectable controls that allow the first user to specify orders to associate with the shopping group. In other words, the first user specifies which orders that other members of the shopping group are permitted to interact with and perform tasks in association with. User interface 210 includes a control 214 that the first user can select to associate the new shopping group with a current shopping cart. For example, the first user may have started a new shopping cart by selecting one or more items for purchase on a website of the retailer (e.g., using a web browser or the dedicated application) to add the items to a virtual shopping cart. While forming the virtual shopping cart, but prior to completing the order, the first user can form the new shopping group as previously described. Selection of the control 214 allows the first user to associate the new shopping group with the current shopping cart.

The user interface 210 further includes a control 216 that allows the first user to associate existing orders with the new shopping group. For example, there may be previous orders that are not yet fulfilled (e.g., have been placed but not yet picked up, or have only recently been fulfilled) and the first user can select one or more radio buttons of the control 216 to allow the other members of the group to perform tasks with those already placed orders, such as picking up the orders or returning items from the orders. The user interface 210 further includes a control that allows the first user to associate the shopping groups with all future orders initiated by the first user. For example, the shopping group may be a shopping group between the first user and the first user's spouse. In such a scenario, the first user may want to grant access to all orders initiated by the first user to the invited second user as a default. When placing future orders, the invited second user (the first user's spouse) will be permitted to interact with the orders as a default. In some implementations, when placing future orders, although the default is to associate the order with the newly formed group, the first user can change settings for those future orders to specify association with a different group (e.g., a shopping group with the first user's parents and siblings) or disassociate the order from all shopping groups.

In some implementations, the user interface 210 can include additional or fewer controls. For example, the user interface 210 can allow the user to not select any orders to associate with the newly formed shopping group. For example, the first user may wish to form a shopping group but has not started a shopping cart for the shopping group. The first user may be preemptively forming a shopping group for future orders (e.g., starting a “Family” shopping group for future grocery orders, or forming a “Office Party” shopping group for a future planned office party). The user interface 210 further includes a control 220 that the first user can select to continue with the shopping group formation process.

Turning to FIG. 2C, the dedicated application executing on the mobile device 102 (or a web browser displaying a website for the retailer) can display a user interface 222 as part of the shopping group formation process. The user interface 222 may be displayed, for example, in response to the first user creating a new shopping group or in response to the first user adding a new person to an already existing shopping group. In some implementations, a group initiator can access the user interface 222 to change permissions for an existing group member, such as by changing spending limits for a group member or adding or removing permissions for an existing group member.

The user interface 222 includes a number of user selectable controls that the first user can select to identify different permissions or functions that a new shopping group member is permitted to perform with respect to shopping carts/orders associated with the shopping group. In some implementations, an instance of the user interface 222 is presented for each member of a shopping group. The user interface 222 can be presented at the time that the first user adds the new person to the shopping group or in response to a newly added group member accepting the invitation to join the shopping group. For example, in response to an invited user accepting an invitation to join the shopping group. The invited user's computing device can initiate a communication to the mobile device 102 (e.g., sent by the invited user's device or by the server system 118). The communication to the mobile device 102 can cause the mobile device 102 to inform the first user that the invited user has accepted the invitation to join the shopping group. The mobile device 102 can then present the user interface 222 (e.g., by the dedicated application, or in a web browser displaying a website of the retailer) in response to selection of one or more controls by the first user.

A first control in the list of controls presented as part of the user interface 222 is a control 224 that grants full access to the identified shopping group member. Full access allows the identified shopping group members to perform all of the same functions with respect to existing and future orders associated with the shopping group as the initiating user/order owner. Such functions can include, adding items to virtual shopping carts, removing items from virtual shopping carts, picking up orders, specifying delivery address/instructions for orders, submitting orders, returning items, initiating new orders, adding payment methods for orders, accessing payment methods associated with the first user (with some specific information for the payment methods obscured, in some implementations), view items entered by others in shopping carts, receive notifications regarding orders associated with the shopping group, share loyalty program rewards and reward points, share discount statuses, share subscription statuses, and other functions associated with placing and fulfilling orders.

The user interface 222 further includes a control 226 that the first user can select to allow the shopping group member to add items to virtual shopping carts for orders associated with the shopping group. The user interface 222 includes a control 228 that the first user can select to allow the shopping group member to remove items from virtual shopping carts for orders associated with the shopping group. The user interface 222 includes a control 230 that the first user can select to allow the shopping group member to pick up orders associated with the shopping group. The user interface 222 includes a control 232 that the first user can select to allow the shopping group member to return items from orders associated with the shopping group. The user interface 222 includes a control 234 that the first user can select to allow the shopping group member to initiate new orders for the shopping group.

The user interface 222 further includes a control 236 that the first user can select to allow the shopping group member to add payment methods for orders associated with the shopping group. For example, if this permission is selected by the first user, the shopping group member can add one or more credit cards, gift cards, or other payment methods in association with the shopping group. In some implementations, the shopping group member can specify whether only the shopping group member is permitted to complete orders for the shopping group using a payment method provided by the shopping group member. In some implementations, the shopping group members can specify that only the shopping group member can use particular payment methods for orders associated with the shopping group (e.g., a credit card entered by the shopping group member) while permitting other members of the shopping group to complete orders for the shopping group using gift cards entered by the shopping group member. In some implementations, the shopping group member can permit one or more other members of the shopping group to use payment methods entered by the shopping group member to complete purchases associated with the shopping group.

The user interface 222 includes a control 238 that the first user can select to allow the shopping group member to access payment methods entered by the first user for orders associated with the shopping group. For example, selection of the control 238 can allow the shopping group member to use a credit card or gift card entered by the first user to complete orders associated with the shopping group. In some implementations, the shopping group member is only permitted to view limited information associated with the first user's payment methods. For example, the shopping group member cannot see a credit card number, expiration date, or other information for a credit card entered by the first user, but can only view the payment methods based on nicknames assigned by the first user or the system. For example, a user interface on the shopping group member's computing device can display payment methods associated with the first user as “Toni's Red Card,” “Toni's Gift Card 1,” or “Toni's Travel Rewards Card.” In some implementations, the first user can specify spending limits for a particular payment method. For example, the first user can specify that the shopping group member cannot place orders of more than $50 on a particular card, cannot spend more than $200 on a particular card within a week or other time period, or is only permitted to place a certain number of orders within a given time period using any particular payment method.

The user interface 222 further includes a control 240 that the first user can select to allow to set spending limits for the shopping group member for orders associated with the shopping group. The first user can enter a value in a field 242 to specify an amount that the shopping group member is allowed to spend per order. In some implementations, the user interface 222 (or another user interface) can permit the first user to specify a time duration for a spending limit. For example, the first user can specify a spending limit amount per week, per month, or per order.

The user interface 222 includes a control 244 that the first user can select to allow the shopping group member to view items added by other members of the shopping group in virtual shopping carts for orders associated with the shopping group. For example, in some implementations, shopping group members are only permitted to view virtual shopping cart items that they have added to the shopping cart and cannot see other items added by other group members. Selection of the control 244 allows the shopping group member to view items added by other members of the shopping group. The user interface 222 includes a control 246 that the first user can select to allow the shopping group member to receive notifications for orders associated with the shopping group. Examples of notifications associated with orders that can be received by designated shopping group members can include notification that an order is ready for pickup, notifications regarding unavailable and/or substitute items, notifications regarding payment method used, notifications indicating that an order has been picked up, notifications indicating that an order has been cancelled, indications that items have been removed from or added to a previously placed order, notifications that an item from an order has been returned, and notifications indicating that an order has been delivered.

In some implementations, the user interface 222 can include more or less permissions/functions for the first user to specify with respect to the shopping group member. For example, the user interface 222 can include a control that permits the shopping group member to specify order fulfillment methods for orders associated with the shopping group (e.g., drive-up/curbside fulfillment, in-store pickup, delivery). As another example, the user interface 222 can include a control that permits the shopping group member to share a loyalty rewards program with the other members of the shopping group. For example, loyalty reward points earned from purchases made by the various shopping group members can be pooled together and redeemed by any of the shopping group members or by specified shopping group members identified by the first user.

In some implementations, the user interface 222 can include a control that permits the shopping group member to use a discount status of the first user. For example, the first user may have a military discount status, employment based (e.g., teacher, nurse, government employee) discount status, or a paid subscription service discount status that the first user can share with the shopping group member. In some implementations, the system can restrict the first user to only permitting a set number of other users (e.g., five other people) to utilize a discount status associated with the first user. In some implementations, the first user is allowed to share a discount status with the shopping group member for both orders associated with the shopping group and orders placed by the shopping group member that are not associated with the shopping group. Similarly, in some implementations, the first user can permit one or more shopping group members to utilize payment methods entered by/associated with the first user to complete both orders associated with the shopping group and orders placed by the other shopping group members that are not associated with the shopping group (e.g., allow children of the first user to place orders using the first user's credit card up to a certain amount each month, without providing all details for the credit card to the children).

In some implementations, rather than providing a list of opt-in permissions/functions for shopping group members, the system can provide a user interface that provides opt-out permissions/functions. For example, certain features, such as viewing items entered by other members, adding items to a shopping cart, removing items from a shopping cart, etc. can be set as default permissions/features permitted by shopping group members and the first user/initiator/owner can select one or more controls to opt-out of certain permissions/functions for a shopping group member.

The user interface 222 can permit the first user to specify different permissions for different members of a shopping group. For example, the first user can use an instance of the user interface 222 for each member of a shopping group to grant different permissions for each shopping group member. For example, the first user can invite the her spouse, her daughter, and her mother to join a shopping group. The first user can grant full access to her spouse with respect to orders associated with the shopping group. The first user can specify that her daughter can add and remove items from orders and has a $50 per month spending limit but is not permitted to pick up or specify delivery for orders initiated by the first user or access payment methods entered by the first user. In this example, the first user can further specify that her mother is permitted to pick up orders but not return items from orders.

The user interface 222 includes a control 248 that the first user can select to submit the selections. This can cause the mobile device 102 to transmit a communication to the server system 118 associating the specified parameters with the identified shopping group member with respect to the designated shopping group. If the shopping group member is a newly added shopping group member, submission of the selections in user interface 222 can cause the server system 118 to transmit an invitation to the mobile device 110 for the second user inviting the second user to join the shopping group with the first user, as previously discussed.

In some implementations, completion of a process for identifying a new shopping group member, such as by selection of the control 248 of FIG. 2C, the control 220 of FIG. 2B, or the control 208 of FIG. 2A, causes the mobile device 102 to display a user interface 250 as shown in FIG. 2D informing the first user that the invitation to the second user has been sent.

In some implementations, the first user can access other user interfaces to adjust various parameters associated with shopping groups. For example, the first user can access a shopping group management user interface to delete shopping groups, change permissions for members of shopping groups (e.g., using a user interface similar to the user interface 222 of FIG. 2C), remove members from shopping groups, start new shopping groups, or add new members to existing shopping groups.

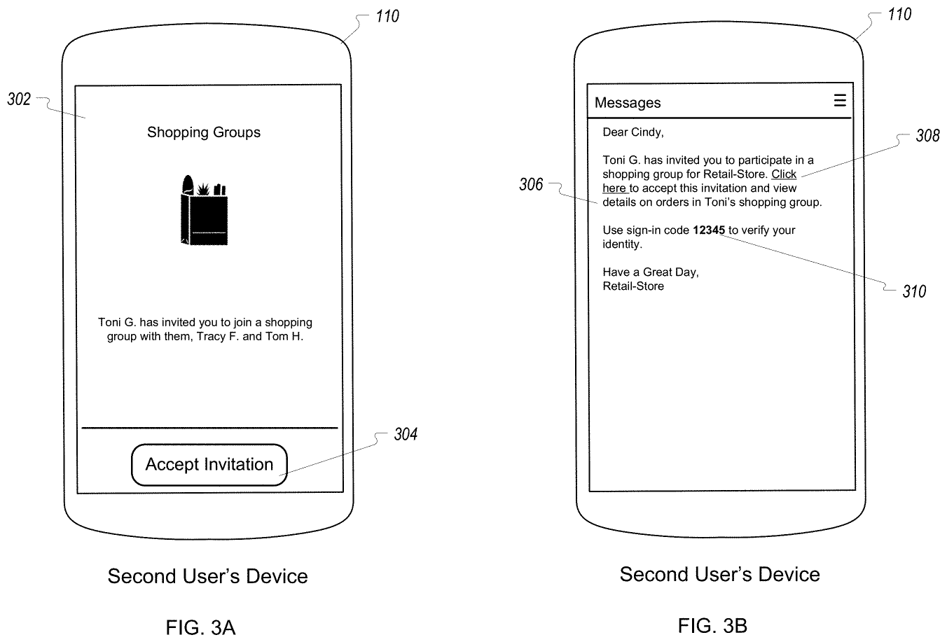

Turning to FIG. 3A, in response to receiving a communication from the server system 118 indicating that the first user has invited the second user (i.e., the user of the mobile device 110) to join a shopping group with the first user, the mobile device 110 can display a notification indicating such to the second user. For example, the server system 118 can provide information to the mobile device 110 to be displayed by an instance of the dedicated application executing on the mobile device 110. The dedicated application can use the information received from the server system 118 to provide a user interface 302 indicating that the first user has invited the second user to join the shopping group. As previously described, the first user may be inviting the second user to a new shopping group or to a previously existing shopping group. In this example, the user interface 302 includes information about the shopping group, including the name of the initiator of the group and other members of the shopping group. In some implementations, upon receiving the communication from the server system 118, the dedicated application can cause the mobile device 110 to provide a push notification to the second user indicating that the second user has received a communication in the dedicated application and/or indicating that the second user has received an invitation to join the shopping group with the first user.

The user interface 302 includes a control 304 that allows the second user to sign in to join the shopping group. For example, selection of the control 304 will accept the invitation on behalf of the second user if the second user is already signed into an account for the retailer. In some implementations, the second user must sign into an account for the retailer or create an account for the retailer to accept the invitation and join the shopping group. If the contact information for the second user provided by the first user does not match contact information associated with the second user's account with the retailer, the second user can initiate a communication to the first user requesting that the first user resubmit the invitation for the second user to join the shopping group using contact information for the second user that matches the contact information for the user associated with the second user's account with the retailer.

In some implementations, rather than being displayed by an instance of the dedicated application executing on the mobile device 110, the user interface 302 can be displayed in a web browser, as an email in an email application, as a text message in a messaging application, or as another type of message. For example, the user interface 302 can be displayed in an email accessed by the second user using a dedicated email application executing on the mobile device 110. The second user can select the control 304 to link to a webpage that allows the second user to log into an account associated with the retailer to accept the invitation, as described above.

FIG. 3B shows an example in which the second user is not previously registered with the retailer or has an account with the retailer registered under a different identifier than that provided by the first user (e.g., the second user is registered with the retailer under a different email address). In this example, the second user receives a message 306, such as an email or text message, at the contact address/phone number provided by the first user as previously described. The message 306 indicates that Toni G. has invited the second user to join a shopping group associated with the retailer “Retail-Store.” The message 306 includes a link 308 that the second user can select to cause the mobile device 110 to display a web page in a browser that allows the user to register with the retailer and/or accept the invitation from the first user. For example, the second user can enter name and contact information to register with the retailer. The server system 118 can then use this information to create a profile for the second user and link the profile with the first user's profile and/or one or more orders placed by the first user. The second user may be able to add additional profile information as well, including payment information for future orders. In some implementations, the second user is required to enter a verification code 310 on a screen displayed in response to selecting the link 308 to verify that the user accepting the invitation to join the shopping group is the person identified by the first user.

In some implementations, such as in a situation in which the second user already has an account with the retailer registered to a different communication address, user name, phone number, etc. than that provided by the first user, the second user can use the verification code 310 to link their account with the retailer with the invitation to be a shopping partner. For example, the second user can select the link 308, which can cause the mobile device 110 to open a webpage in a web browser that permits the second user to log into their account with the retailer. As another example, selecting the link 308 can cause the mobile device 110 to launch the dedicated application associated with the retailer. The dedicated application can then allow the second user to log into their account with the retailer. In some instances, the second user may already be logged into their account through the dedicated application due to previous interactions with the dedicated application. If the login (e.g., email address) associated with the second user's account is different from the login/contact method provided by the first user, the dedicated application (or web page displayed in a browser) can request that the second user enter the verification code 310 displayed in the message 306 to verify that the second user is in fact the person identified by the first user as a requested shopping partner.

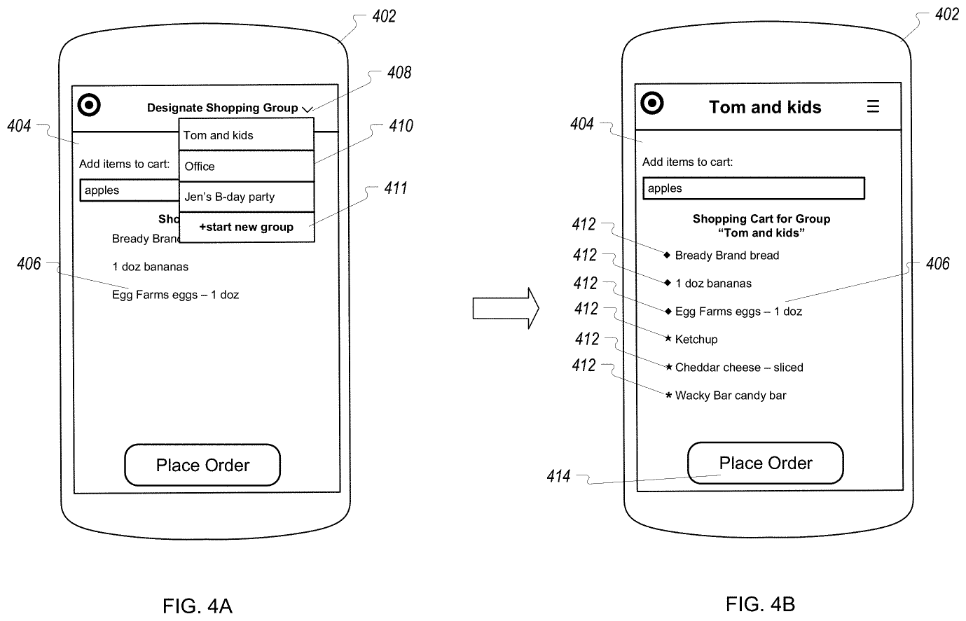

FIG. 4A shows a user interface 404 executing on a mobile device 402. The mobile device can, for example, be the mobile device 102 of the first user, the mobile device 110 of the second user, or the mobile device of a different member of a shopping group. The user interface 404 shows that the user of the 402 (the order owner) has started an order by adding items to a virtual shopping cart 406. The user interface 404 shows items that have been added to the virtual shopping cart 406 so far by the order owner. The user interface 404 further includes a user selectable control 408 that the order owner can select to share the current shopping cart with a shopping group. In the example shown, selection of the control 408 causes the user interface 404 to display a list 410 of shopping groups of which the order owner is a member and is permitted to initiate orders. The listed shopping groups in the list 410 can be, for example, shopping groups created by the order owner and/or shopping groups for which the order owner has been granted permission to initiate new orders. The order owner can select one of the listed shopping groups from the list 410 to associate the current order with the selected shopping group. Upon selecting a shopping group, the mobile device 402 transmits a communication to the server system 118 through the network 116 which causes the server system 118 to send communications to each of the members of the selected shopping group that the order owner has started a new order for the shopping group and invited them to participate in the purchase process for the shared virtual shopping cart. The order owner and the other members of the shopping group (who are authorized to perform such functions with respect to the shopping group) can then proceed to add items to the shared shopping cart

In some implementations, the list 410 includes a selectable control 411 that allows the order owner to initiate formation of a new shopping group. Selection of the control 411 can allow the order owner to invite one or more other people to join a new shopping group associated with the virtual shopping cart 406 and specify permissions that each shopping group member has with respect to the virtual shopping cart 406 as previously described.

FIG. 4B shows an updated version of user interface 404 displayed on the mobile device 402 including the virtual shopping cart 406 and showing that the order owner has selected the group “Tom and kids” to share in the shopping experience for the currently displayed shopping cart. In this example, the updated user interface 404 further includes icons 412 displayed next to each item in the virtual shopping cart 406 to indicate which member of the shopping group added each item. In the example depicted, the diamond icon indicates items added by the order originator while the star icon indicates items added by a second member of the shopping group and the asterisk icon indicates items added by a third member of the group. Indications of which member of a shopping group added which items can take other forms, such as display of avatars, differences in font, differences in text color, etc. In some implementations, the user interface 404 can further identify when two members of the shopping group have added identical or similar items. For example, the server system 118 can identify that the shopping cart includes two different loafs of bread added by two different group members. The server system 118 can communicate with the mobile device 402 to cause the user interface 404 to indicate that two members of the shopping group have added bread to the shared shopping cart by displaying those items in red and/or including a pop-up notification to indicate a possible duplicate item in the shopping cart. The order owner (or one of the other shopping cart members) can then resolve potential duplicate orders by removing duplicate items from the shopping cart or choosing to leave the flagged items in the cart.

In some implementations, shopping group members are permitted to add comments or notations to items in the shared virtual shopping cart to allow the group members to collaboratively form the shopping cart. For example, the first user can add a comment to a listing for a tube of toothpaste added by the second user stating “I think we have toothpaste at home but I'll check later.” As another example, the second user can add a notation to an item at the time of adding the item to the shared virtual shopping cart stating “I thought we'd make enchiladas on Thursday!” As yet another example, the first user can add a notation to an item at the time of adding the item stating “Tom, this is the brand you like, right?”.

The user interface 222 further includes a control 414 that can be selected by the order owner to place the order (e.g., by entering payment information or selecting previously stored payment information associated with the order owner or another member of the shopping group). In some implementations, the system can allow members of a shopping group to split payment. For example, a second shopping group member can indicate that they will pay for $20 of the order, a third shopping group member can indicate that they will pay for $35 of the order, and the order owner can pay for the remaining cost of the order. As another example, the shopping group members can elect to split the cost evenly between all or a selected number of members of the shopping group and each submit payment information for their respective portions. If the order is a pickup order, upon placing the order, one of the members of the shopping group that is designated as being permitted to pick up orders for the shopping group can pick up the order at the designated time using a designated fulfillment method (e.g., drive-up fulfillment or in-store pickup). Alternatively, one of the group members that is permitted to specify a fulfillment method for the order can designate delivery fulfillment and provide an address for delivery of the order. In some implementations, when completing the order, a user can identify an order fulfillment method in addition to providing payment information. For example, the order owner, or another shopping group member that is authorized to identify a fulfillment method for the group, can select drive-up/curb-side, in-store pickup, delivery, or another fulfillment method when checking out.

In some implementations, members of a shopping group can interact in other ways in addition to forming shared virtual shopping carts and collaboratively placing and fulfilling orders. For example, members of a shopping group can share listings for items or services for sale by the retailer along with notations. For example, the first user can send a communication to other members of a shopping group along with a listing for a patio furniture set along with a notation of “what do you think about these for the back yard?”. As another example, the second user can send a listing for hamburger buns to the third user that is accessible by the third user via the dedicated application executing on the third user's computing device along with a notation of “this is the brand you like, right?”. A member of the shopping group can click on a shared listing to add the item represented by the listing to the shared shopping cart. In some implementations, a user can share listings for items with an entire designated shopping group or with only selected members of the shopping group.

In some implementations, users of a shopping group can collaboratively form and share shopping lists. For example, one or more members of a shopping group can form a shopping list by selecting listings for items available from the retailer to add to the shopping list. Rather placing the list of items as an order, one or the members of the shopping group can use the collaborative shopping list to purchase items when shopping at a physical location of the retailer in person. The shopping group member performing the in-person shopping can communicate with other members of the shopping group, via the instances of the dedicated application executing on each shopping group member's computing device, to discuss items on the list, inquire about replacements for unavailable items, or to allow other shopping group members to add items to the shopping list. The shopping group member performing the in-person shopping can use the dedicated application to check items off of the shopping list as they are placed in the user's physical shopping cart. Members of the shopping group can also include notations along with items added to the shopping list or add notations associated with the shopping list in general.

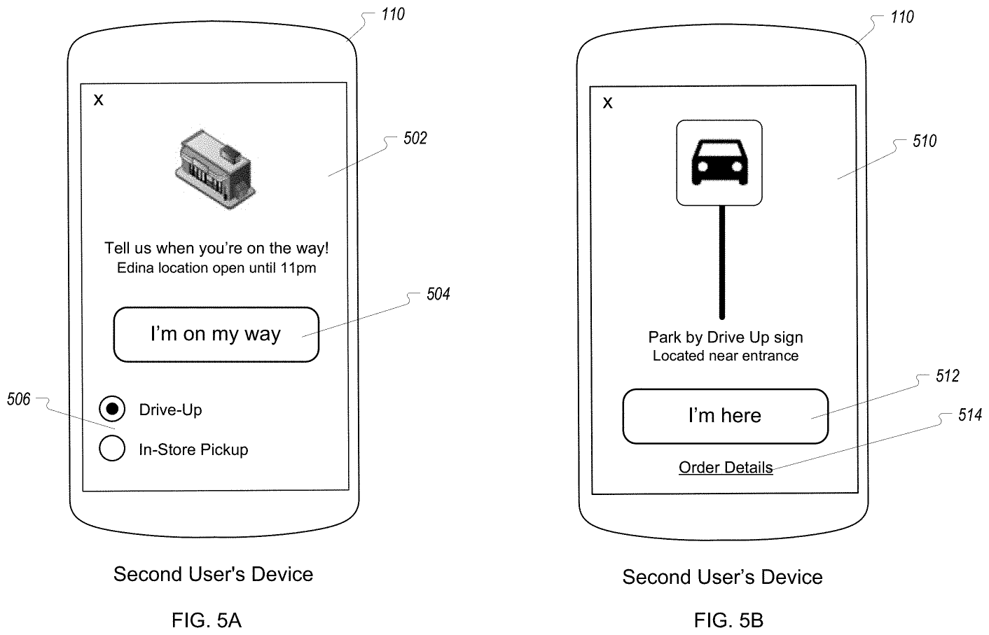

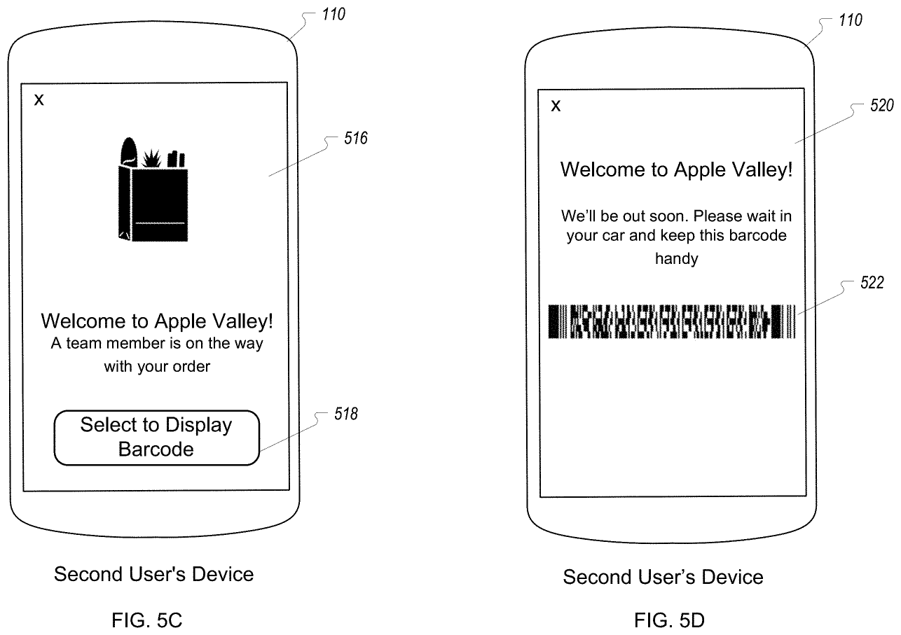

FIG. 5A shows a user interface 502 that a member of a shopping group that is authorized to pickup an order associated with the shopping group can use to indicate that they are on their way to pick up an order placed by a member of the shopping group. For example, referring back to the example from FIG. 1, the first user (having the mobile device 102) placed an order with the retailer and associated the order with the shopping group that includes the second, third, and fourth users having the mobile devices 110, 112, and 114 respectively. The first user may have associated the shopping group with the order while creating the virtual shopping cart for the order to allow the second, third, and fourth users to participate forming the virtual shopping cart in a collaborative matter. Alternatively, the first user may have associated the shopping group with the order after placing the order, to allow one or more members of the shopping group to perform post-purchase actions with respect to the order, such as pick up the order, return items, add items to the order prior to fulfillment, or specify a fulfillment method for the order.

In the example shown in FIG. 5A, the second user is authorized to pickup orders associated with the shopping group and to specify a fulfillment method for the order. In this example, the user interface 502 is displayed on the mobile device 110 of the second user. In some implementations, the second user can select one or more controls in the dedicated application or on a website of the retailer displayed in a browser executing on the mobile device 110 to cause the user interface 502 to be displayed. As another example, the second user can navigate to a menu screen of the dedicated application to review a list of all orders placed by the second user and orders for which the user is identified as an authorized pickup person for orders associated with shopping groups of which the second user is a member. In some implementations, the orders placed by the second user are displayed differently than orders placed by other members of shopping groups of which the second user is a member. For example, orders placed by the second user can be displayed in a first color while orders for which the second user is an authorized pickup person but did not place the order can be displayed using a second color. In another example, orders associated with different shopping groups can be displayed differently, such as a specific color, icon, or graphic for each shopping group displayed alongside orders for that group with a different color, icon, or graphic for orders placed by the second user not in association with a shopping group. In this example, the second user can select a listing for the order placed by the first user in association with the shopping group to which both the first user and the second user belong to cause the dedicated application to display user interface 502.

The user interface 502 can include instructions to the second user to indicate when they have begun to travel toward the fulfillment location for the order, such as a brick and mortar store associated with the retailer, and other relevant information, such as store hours for the fulfillment location. The user interface 502 further includes a user selectable icon 504 that allows the second user to indicate that they have begun to travel toward the fulfillment location. Upon selection of the icon 504 by the second user, the mobile device 110 communicates with the server system 118 to indicate that the second user has begun to travel toward the fulfillment location. In some implementations, the server system 118 can determine an estimated time of arrival for the second user based on an initial location for the route to the fulfillment location (such as the second user's home address, which can be stored as part of the second user's profile information) as described above (e.g., by performing calculations or by communicating with a mapping system). The server system 118 can then communicate with a computing device operated by an employee of the retailer at the fulfillment location to inform the employee that the second user is on the way. This notification can allow the employee to begin gathering items for the order placed by the first user such that the order items can be provided to the second user upon arrival of the second user at the fulfillment location.

In some implementations, in response to the second user opening the dedicated application or in response to the user selecting the icon 504, the dedicated application can request temporary access to location information for the mobile device 110. If the second user permits the dedicated application temporary access to location information (e.g., only while the dedicated application is open), the dedicated application can provide the mobile device 110 location information to the server system 118 to assist the server system 118 in identifying the estimated time of arrival of the second user at the fulfillment location. In some implementations, the user interface 502 includes a control 506 that allows the second user to change the order fulfillment type. In the example shown in FIG. 5A, the control 506 indicates that the second user has selected drive-up order fulfillment and further includes an option to change the order fulfillment type to in-store pickup.

FIG. 5B shows user interface 510 for the mobile device 110 that can be used by the second user to inform one or more employees of the fulfillment location that they have arrived to pick up the order associated with the shopping group when the second user (or another member of the shopping group) has selected drive-up fulfillment for the order. The user interface 510 can include instructions to the second user on where to park for drive-up fulfillment and can also provide instructions to prompt the user to indicate when they have arrived. The user interface 510 includes a user selectable control 512 that allows the second user to indicate that they have arrived at the fulfillment location. Upon selection of the control 512 by the second user, the mobile device 110 communicates with the server system 118 to indicate that the second user has arrived at the fulfillment location. In some implementations, the user interface 510 includes a user selectable control 514 that allows the user to view details on the order.

FIG. 5C shows an example user interface 516 that can be displayed in response to a determination that the second user has arrived at the fulfillment location. For example, upon the dedicated application determining that the second user has arrived at the store, the dedicated application displays the user interface 516. As another example, the server system 118 can determine that the second user has arrived at the fulfillment location and send a communication to the mobile device 110 to cause the mobile device 110 to display the user interface 516. The user interface 516 can include a greeting and information such as an indication that an employee of the store will arrive with the items for the order soon. In some implementations, the user interface 516 can include a timer (not shown) that indicates an amount of time since the second user has arrived at the store 516. In some implementations, the user interface 516 includes a user selectable control 518 that, when selected, causes the dedicated application to display a barcode that can be scanned by an employee of the retailer, e.g., using a mobile device, to verify the order.

FIG. 5D shows an example user interface 520 for the second user's mobile device 110 that includes a barcode 522. The user interface 520 having the barcode 522 can be displayed, for example, in response to selection by the user of the control 518 of FIG. 5C or in response to the second user navigating through a menu of the dedicated application. In some implementations, the user interface 520 having the barcode 522 is automatically displayed in response to a determination that the second user has arrived at the fulfillment location. In some implementations, the barcode 522 can be displayed as part of a notification on a lock screen of the mobile device 110. The barcode 522 can be a unique barcode that is associated with the second user. In other implementations, the barcode 522 can be a unique barcode that is associated with the order associated with the shopping group, or the barcode 522 can be associated with all active orders associated with the second user (e.g., shopping group orders for which the second user is an authorized pickup person and orders placed by the second user). In such implementations, the barcode 522 can change between each order for the same user. In some implementations, the barcode 522 is tied to a specific payment method. In some implementations, another verification method can be used, such as a matrix barcode, a unique character string, or other unique indicator.

The barcode 522 can be scanned by the employee, e.g., using the employee's computing device, to verify the second user's identity and verify that the second user is authorized to pick up the order associated with the shopping group. For example, if the second user has elected to pick up the order using drive-up fulfillment, the employee can retrieve the bags containing the items for the order from appropriate storage bins and bring the bags out to the second user's vehicle. The employee can then scan the barcode 522. For example, the employee's computing device can prompt the employee to scan the barcode 522 displayed on the second user's mobile device 110 using a camera of a computing device used by the employee, an infrared scanner of the employee's computing device, or other scanning functionality of the employee's computing device. In some implementations, the employee's computing device can allow the employee to select a mechanism for scanning the barcode 522. In some implementations, the employee can select one or more input buttons of the employee's computing device (e.g., physical buttons or virtual buttons displayed on a touch screen) to scan the barcode 522 using the camera of the employee's computing device and can select one or more other different buttons of the employee's computing device to scan the barcode 522 using the infrared scanner. The barcode 522 can be scanned by the employee using the employee's computing device as part of a drive-up fulfillment process or an in-store pickup fulfillment process.

Upon scanning the barcode 522, the employee's computing device can compare identifying information associated with or conveyed by the barcode 522 to identifying information for the second user or the order to verify the second user's identity and/or to verify that the employee is providing the correct order(s) to the second user. In some implementations, such a determination is made at a central computer of the fulfillment location in communication with the employee's computing device or at the server system 118.

For example, the barcode 522 can comprise or include a unique identifier for the second user. Upon scanning the barcode 522, the employee's computing device can communicate with the server system 118 to retrieve a list of orders associated with the identifier for the second user. For example, the server system 118 can access a database of orders and identify all orders that are ready for pickup for which the second user is identified as an authorized pickup person (including all orders placed by the second user). The server system 118 communicates this information to the employee's computing device (e.g., via a central computer of the fulfillment location). The employee's computing device then displays information on each of the identified orders that the second user is authorized to pick up to allow the employee to provide the correct orders to the second user. For example, the employee's computing device can display order numbers for the orders. As another example, the employee's computing device can display location information for bags containing the items for the orders (e.g., one or more shelf or bin locations at a drive-up order fulfillment staging area), a number of bags for each order, an indication as to whether or not any of the orders includes age restricted items (e.g., cold medicine, alcohol, etc.), and other information for the orders.

In some implementations, rather than retrieving this order information in response to scanning the barcode 522 (or another optically readable code), this information is retrieved in response to receiving the earlier described notification that the second user has arrived at the fulfillment location. For example, the server system 118 can receive the notification that the second user has arrived at the fulfillment location or is about to arrive at the fulfillment location. The server system 118 can then use a unique identifier for the second user to identify all orders for which the second user has placed the order or the second user is an authorized pickup person. For example, the unique identifier for the second user can be associated with a number of orders in an “owner” field, an “authorized pickup person” field, or an “authorized shopping group member” field. The server system 118 retrieves the relevant information for each of these orders and provides it to the employee's computing device for presentation to the employee to allow the employee to gather the bags for each of the orders and bring them to the second user's vehicle. The employee can then scan the barcode 522 displayed by the second user's mobile device 110 to verify the second user's identity and/or that the second user is authorized to pick up the identified orders. Upon verification, the employee provides the items for the orders to the second user. In some implementations, the employee's computing device can include an interface for collecting a signature from the second user.

In some implementations, a verification code other than a barcode is used, for example, another form of optically scannable code, such as a QR code, can be used in place of the barcode. As another example, a human readable code can be used in place of the bar code. For example, the second user's mobile device 110 can display a numeric or alphanumeric code. The employee can visually read numeric or alphanumeric code displayed on the second user's mobile device 110 and manually enter the numeric or alphanumeric code into a user interface of the employee's computing device. All descriptions made with respect to the above example involving the barcode 522 also apply to examples in which a different type of scannable code or a human readable code is displayed by the second user's mobile device 110. For example, a numeric or alphanumeric code displayed by the second user's mobile device 110 and manually entered into the employee's computing device by the employee can be associated with the order, with the shopping group member, with the shopping group as a whole, or with the order owner. As yet another example, the employee's computing device can verify that the second user is authorized to pick up the order by collecting biometric information for the second user, such as a fingerprint or retina scan.

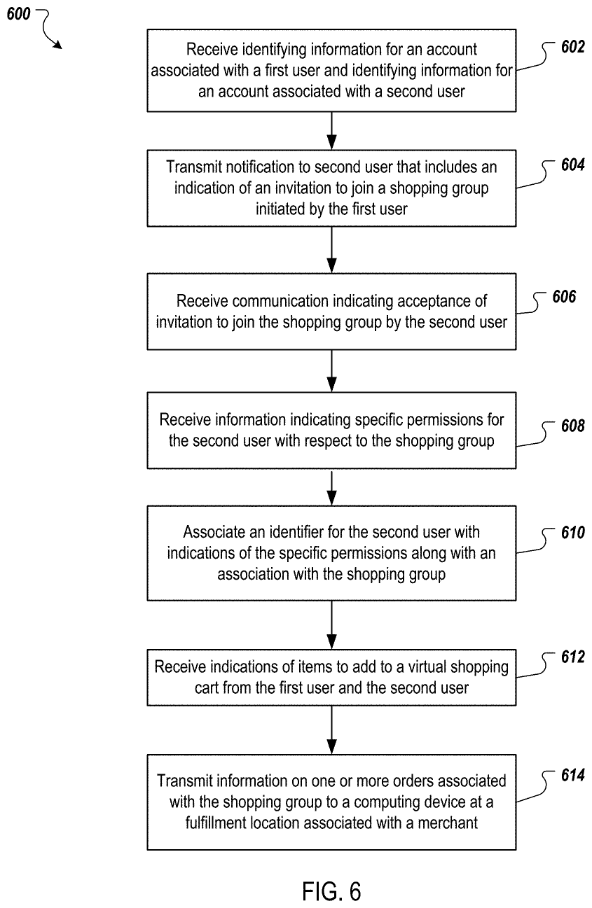

FIG. 6 is a flowchart of an example process 600 to be performed by one or more computing devices in a system for facilitating formation of shopping groups for collaborative online shopping, order placement, and order fulfillment. For example, the process 600 can be performed by the server system 118 of FIG. 1. The steps of the process 600 can be performed in a different order than shown in this example. The process 600 can also include additional steps not shown. The process 600 includes receiving identifying information for an account associated with a first user and identifying information for an account associated with a second user from a computing device operated by the first user (602). For example, a user who has an account with a retailer can form a new shopping group by providing information on a second user that the first user wishes to invite to join the shopping group. The computing device of the first user can transmit a communication to a server system that includes the identifying information for the second user entered by first user and also includes an identifier for the first user, such as a user ID or username for the first user that is associated with an account for the first user with the retailer.

A notification is transmitted to the second user that includes an indication of an invitation to join a shopping group initiated by the first user (604). For example, the notification can include identifying information for the first user (e.g., the first user's name) and text indicating that the first user has invited the second user to join a shopping group. The notification can further include information that prompts a computing device of the second user to display instructions on how to accept the invitation and join the shopping group initiated by the first user.

The process 600 further includes receiving a communication indicating acceptance of the invitation to join the shopping group by the second user (606). For example, second user can log into an account with the retailer on her computing device and select a control displayed by a user interface on the computing device to accept the invitation to join the shopping group. The second user's computing device then transmits a communication to the server system indicating that the second user has accepted the invitation to join the shopping group.

The server system receives information indicating specific permissions for the second user with respect to the shopping group (608). This information can be received for example, along with the identifying information for the account associated with the second user at step 602, after the second user has accepted the invitation to join the shopping group, or at another time. The first user can select specific permissions to indicate actions that the second user is authorized to perform with respect to orders associated with the shopping group. Such actions can include, adding items to virtual shopping carts, removing items from virtual shopping carts, picking up orders, specifying delivery address/instructions for orders, submitting orders, returning items, initiating new orders, adding payment methods for orders, accessing payment methods associated with the first user (with some specific information for the payment methods obscured, in some implementations), view items entered by others in shopping carts, receive notifications regarding orders associated with the shopping group, share loyalty program rewards and reward points, share discount statuses, share subscription statuses, and other functions associated with placing and fulfilling orders.

The server system associates an identifier for the second user with indications of the specific permissions along with an association with the shopping group (610). These two associating steps may be performed at different times. For example, at the time that the first user submits the invitation inviting the second user to join the shopping group, or at the time that the second user accepts the invitation, the server system can associate one or more identifiers for the second user with the shopping group. For example, an identifier for the shopping group can be stored in a shopping group database accessible by the server system and an identifier for the first user can be stored in a “shopping group initiator” field in association with the shopping group and an identifier for the second user can be stored in a “shopping group member” field in association with the shopping group. At the time of storing these associations, or at another time, indicators indicating which actions that the second user is authorized to perform can be associated with the identifier for the second user in association with the shopping group. This information on specific permissions for the second user in association with the shopping group can be stored, for example, at the time that the indications of the specific permissions is received from a computing device of the first user. In some implementations, the first user can change permissions for other shopping group members (including the second user) at any time.

Indications of items to add to a virtual shopping cart from the first user and the second user are received (612). For example, the first and second user can use their respective computing devices to add items to a virtual shopping cart and remove items from the virtual shopping cart in a collaborative shopping process. In some implementations, each user can add comments in association with items added to the shopping cart to further enhance the collaborative shopping process (e.g., a note of “I added this so we can make lasagna on Tuesday” with an added item of a can of tomatoes.

The process 600 further includes transmitting information on one or more orders associated with the shopping group (e.g., orders collaboratively formed and placed by members of the shopping group) to a computing device at a fulfillment location associated with a merchant (614). This can include transmitting information such as order numbers for the orders, items included in the orders, and identifying information for the shopping group members (such as unique identifiers for each shopping group member). The computing device of the fulfillment location can provide this information to the employee to allow the employee to gather the items for the orders and stage bags for the orders at a staging location in preparation of one or more of the shopping group members arriving at the fulfillment location to pick up the order.

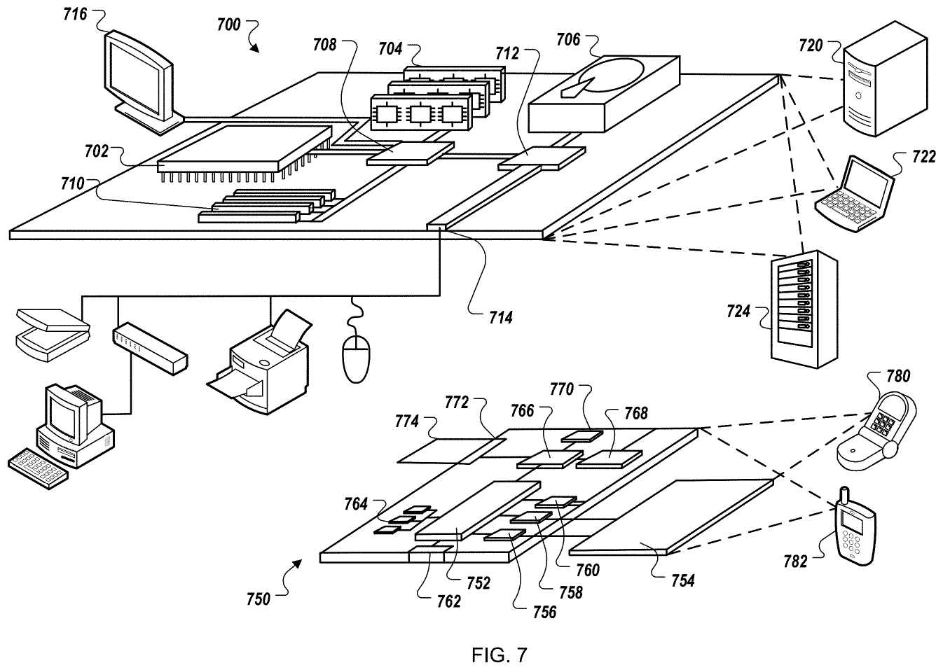

FIG. 7 shows an example of a computing device 700 and an example of a mobile computing device that can be used to implement the techniques described here. The computing device 700 is intended to represent various forms of digital computers, such as laptops, desktops, workstations, personal digital assistants, servers, blade servers, mainframes, and other appropriate computers. The mobile computing device is intended to represent various forms of mobile devices, such as personal digital assistants, cellular telephones, smart-phones, and other similar computing devices. The components shown here, their connections and relationships, and their functions, are meant to be exemplary only, and are not meant to limit implementations of the inventions described and/or claimed in this document.

The computing device 700 includes a processor 702, a memory 704, a storage device 706, a high-speed interface 708 connecting to the memory 704 and multiple high-speed expansion ports 710, and a low-speed interface 712 connecting to a low-speed expansion port 714 and the storage device 706. Each of the processor 702, the memory 704, the storage device 706, the high-speed interface 708, the high-speed expansion ports 710, and the low-speed interface 712, are interconnected using various busses, and may be mounted on a common motherboard or in other manners as appropriate. The processor 702 can process instructions for execution within the computing device 700, including instructions stored in the memory 704 or on the storage device 706 to display graphical information for a GUI on an external input/output device, such as a display 716 coupled to the high-speed interface 708. In other implementations, multiple processors and/or multiple buses may be used, as appropriate, along with multiple memories and types of memory. Also, multiple computing devices may be connected, with each device providing portions of the necessary operations (e.g., as a server bank, a group of blade servers, or a multi-processor system).

The memory 704 stores information within the computing device 700. In some implementations, the memory 704 is a volatile memory unit or units. In some implementations, the memory 704 is a non-volatile memory unit or units. The memory 704 may also be another form of computer-readable medium, such as a magnetic or optical disk.

The storage device 706 is capable of providing mass storage for the computing device 700. In some implementations, the storage device 706 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods, such as those described above. The computer program product can also be tangibly embodied in a computer- or machine-readable medium, such as the memory 704, the storage device 706, or memory on the processor 702.

The high-speed interface 708 manages bandwidth-intensive operations for the computing device 700, while the low-speed interface 712 manages lower bandwidth-intensive operations. Such allocation of functions is exemplary only. In some implementations, the high-speed interface 708 is coupled to the memory 704, the display 716 (e.g., through a graphics processor or accelerator), and to the high-speed expansion ports 710, which may accept various expansion cards (not shown). In the implementation, the low-speed interface 712 is coupled to the storage device 706 and the low-speed expansion port 714. The low-speed expansion port 714, which may include various communication ports (e.g., USB, Bluetooth, Ethernet, wireless Ethernet) may be coupled to one or more input/output devices, such as a keyboard, a pointing device, a scanner, or a networking device such as a switch or router, e.g., through a network adapter.

The computing device 700 may be implemented in a number of different forms, as shown in the figure. For example, it may be implemented as a standard server 720, or multiple times in a group of such servers. In addition, it may be implemented in a personal computer such as a laptop computer 722. It may also be implemented as part of a rack server system 724. Alternatively, components from the computing device 700 may be combined with other components in a mobile device (not shown), such as a mobile computing device 750. Each of such devices may contain one or more of the computing device 700 and the mobile computing device 750, and an entire system may be made up of multiple computing devices communicating with each other.

The mobile computing device 750 includes a processor 752, a memory 764, an input/output device such as a display 754, a communication interface 766, and a transceiver 768, among other components. The mobile computing device 750 may also be provided with a storage device, such as a micro-drive or other device, to provide additional storage. Each of the processor 752, the memory 764, the display 754, the communication interface 766, and the transceiver 768, are interconnected using various buses, and several of the components may be mounted on a common motherboard or in other manners as appropriate.

The processor 752 can execute instructions within the mobile computing device 750, including instructions stored in the memory 764. The processor 752 may be implemented as a chipset of chips that include separate and multiple analog and digital processors. The processor 752 may provide, for example, for coordination of the other components of the mobile computing device 750, such as control of user interfaces, applications run by the mobile computing device 750, and wireless communication by the mobile computing device 750.

The processor 752 may communicate with a user through a control interface 758 and a display interface 756 coupled to the display 754. The display 754 may be, for example, a TFT (Thin-Film-Transistor Liquid Crystal Display) display or an OLED (Organic Light Emitting Diode) display, or other appropriate display technology. The display interface 756 may comprise appropriate circuitry for driving the display 754 to present graphical and other information to a user. The control interface 758 may receive commands from a user and convert them for submission to the processor 752. In addition, an external interface 762 may provide communication with the processor 752, so as to enable near area communication of the mobile computing device 750 with other devices. The external interface 762 may provide, for example, for wired communication in some implementations, or for wireless communication in other implementations, and multiple interfaces may also be used.

The memory 764 stores information within the mobile computing device 750. The memory 764 can be implemented as one or more of a computer-readable medium or media, a volatile memory unit or units, or a non-volatile memory unit or units. An expansion memory 774 may also be provided and connected to the mobile computing device 750 through an expansion interface 772, which may include, for example, a SIMM (Single In Line Memory Module) card interface. The expansion memory 774 may provide extra storage space for the mobile computing device 750, or may also store applications or other information for the mobile computing device 750. Specifically, the expansion memory 774 may include instructions to carry out or supplement the processes described above and may include secure information also. Thus, for example, the expansion memory 774 may be provide as a security module for the mobile computing device 750, and may be programmed with instructions that permit secure use of the mobile computing device 750. In addition, secure applications may be provided via the SIMM cards, along with additional information, such as placing identifying information on the SIMM card in a non-hackable manner.

The memory may include, for example, flash memory and/or NVRAM memory (non-volatile random access memory), as discussed below. In some implementations, a computer program product is tangibly embodied in an information carrier. The computer program product contains instructions that, when executed, perform one or more methods, such as those described above. The computer program product can be a computer- or machine-readable medium, such as the memory 764, the expansion memory 774, or memory on the processor 752. In some implementations, the computer program product can be received in a propagated signal, for example, over the transceiver 768 or the external interface 762.

The mobile computing device 750 may communicate wirelessly through the communication interface 766, which may include digital signal processing circuitry where necessary. The communication interface 766 may provide for communications under various modes or protocols, such as GSM voice calls (Global System for Mobile communications), SMS (Short Message Service), EMS (Enhanced Messaging Service), MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication may occur, for example, through the transceiver 768 using a radio-frequency. In addition, short-range communication may occur, such as using a Bluetooth, WiFi, or other such transceiver (not shown). In addition, a GPS (Global Positioning System) receiver module 770 may provide additional navigation- and location-related wireless data to the mobile computing device 750, which may be used as appropriate by applications running on the mobile computing device 750.

The mobile computing device 750 may also communicate audibly using an audio codec 760, which may receive spoken information from a user and convert it to usable digital information. The audio codec 760 may likewise generate audible sound for a user, such as through a speaker, e.g., in a handset of the mobile computing device 750. Such sound may include sound from voice telephone calls, may include recorded sound (e.g., voice messages, music files, etc.) and may also include sound generated by applications operating on the mobile computing device 750.

The mobile computing device 750 may be implemented in a number of different forms, as shown in the figure. For example, it may be implemented as a cellular telephone 780. It may also be implemented as part of a smart-phone 782, personal digital assistant, or other similar mobile device.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications, or code) include machine instructions for a programmable processor and can be implemented in a high-level procedural and/or object-oriented programming language and/or in assembly/machine language. As used herein, the terms machine-readable medium and computer-readable medium refer to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term machine-readable signal refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

What is claimed is:

1. A computer implemented method comprising:
receiving, by at one or more computing devices and from a first computing device, identifying information for an account associated with a first user and identifying information for a second user, wherein the identifying information for the account associated with the second user is provided by the first user via a user interface of the first computing device;
transmitting, by the one or more computing devices and in response to receiving the identifying information for the second user, a notification to the second user indicating that the second user has been invited to join a shopping group initiated by the first user;
receiving, by the one or more computing devices and from a second computing device, a communication indicating acceptance, by the second user, of the invitation to join the shopping group initiated by the first user;
receiving, by the one or more computing devices, information indicating specific permissions for the second user with respect to the shopping group, the information indicating specific permissions for the second user having been provided by the first user;
associating an identifier for the second user with an electronic record for the shopping group;
associating at least one of the specific permissions with the identifier for the second user within the electronic record for the shopping group;
receiving, by the one or more computing devices and from the first computing device, an indication of a first item to add to a virtual shopping cart associated with the shopping group;
receiving, by the one or more computing devices and from the second computing device, an indication of a second item to add to the virtual shopping cart; and
transmitting information on an order placed in association with the virtual shopping cart for the shopping group to a computing device at a fulfillment location associated with a merchant.

2. The method of claim 1, wherein associating an identifier for the second user with the electronic record for the shopping group comprises:
using the identifying information for the second user provided by the first user to identify a profile for the second user, the profile being a profile associated with the merchant;
retrieving a unique identifier for the second user from the profile for the second user; and
entering the unique identifier for the second user into a group member field within the electronic record for the shopping group.

3. The method of claim 2, further comprising:
receiving, from the first computing device, information indicating that the second user is permitted to pick up orders associated with the shopping group; and
in response to receiving the information indicating that the second user is permitted to pick up orders associated with the shopping group, associating a permission to pick up orders with the unique identifier for the second user within the electronic record for the shopping group.

4. The method of claim 1, further comprising:
associating information for a first payment method provided by the first user with the shopping group;
associating information for a second payment method provided by the second user with the shopping group;
receiving an indication to split the payment for the order placed in association with the virtual shopping cart;
charging a first portion of the amount for the order to the first payment method; and
charging a second portion of the amount for the order to the second payment method.

5. The method of claim 1, wherein the first user is logged into an account for the merchant on the first computing device and the second user is logged into an account for the merchant on the second computing device.

6. The method of claim 1, wherein the information indicating specific permissions for the second user with respect to the shopping group includes an indication of a spending limit for the second user.

7. The method of claim 6, further comprising:
responsive to receiving the indication of the second item to add to the virtual shopping cart, confirming that addition of the second item to the virtual shopping cart will not cause the second user to exceed the spending limit;
adding the second item to the virtual shopping cart responsive to confirming that addition of the second item to the virtual shopping cart will not cause the second user to exceed the spending limit.

8. The method of claim 6, further comprising:
responsive to receiving the indication of the second item to add to the virtual shopping cart, determining that addition of the second item to the virtual shopping cart will exceed the spending limit for the second user;
rejecting addition of the second item to the virtual shopping cart responsive to determining that addition of the second item to the virtual shopping cart will exceed the spending limit for the second user.

9. A system comprising:
one or more processors; and
computer memory containing instructions that, when executed by the one or more processors, cause the system to perform operations comprising:
receiving, by at one or more computing devices and from a first computing device, identifying information for an account associated with a first user and identifying information for a second user, wherein the identifying information for the account associated with the second user is provided by the first user via a user interface of the first computing device;
transmitting, by the one or more computing devices and in response to receiving the identifying information for the second user, a notification to the second user indicating that the second user has been invited to join a shopping group initiated by the first user;
receiving, by the one or more computing devices and from a second computing device, a communication indicating acceptance, by the second user, of the invitation to join the shopping group initiated by the first user;
receiving, by the one or more computing devices, information indicating specific permissions for the second user with respect to the shopping group, the information indicating specific permissions for the second user having been provided by the first user;
associating an identifier for the second user with an electronic record for the shopping group;
associating at least one of the specific permissions with the identifier for the second user within the electronic record for the shopping group;
receiving, by the one or more computing devices and from the first computing device, an indication of a first item to add to a virtual shopping cart associated with the shopping group;
receiving, by the one or more computing devices and from the second computing device, an indication of a second item to add to the virtual shopping cart; and
transmitting information on an order placed in association with the virtual shopping cart for the shopping group to a computing device at a fulfillment location associated with a merchant.

10. The system of claim 9, wherein associating an identifier for the second user with the electronic record for the shopping group comprises:
using the identifying information for the second user provided by the first user to identify a profile for the second user, the profile being a profile associated with the merchant;
retrieving a unique identifier for the second user from the profile for the second user; and
entering the unique identifier for the second user into a group member field within the electronic record for the shopping group.

11. The system of claim 10, the operations further comprising:
receiving, from the first computing device, information indicating that the second user is permitted to pick up orders associated with the shopping group; and
in response to receiving the information indicating that the second user is permitted to pick up orders associated with the shopping group, associating a permission to pick up orders with the unique identifier for the second user within the electronic record for the shopping group.

12. The system of claim 9, the operations further comprising:
associating information for a first payment method provided by the first user with the shopping group;
associating information for a second payment method provided by the second user with the shopping group;
receiving an indication to split the payment for the order placed in association with the virtual shopping cart;
charging a first portion of the amount for the order to the first payment method; and
charging a second portion of the amount for the order to the second payment method.

13. The system of claim 9, wherein the first user is logged into an account for the merchant on the first computing device and the second user is logged into an account for the merchant on the second computing device.

14. The system of claim 9, wherein the information indicating specific permissions for the second user with respect to the shopping group includes an indication of a spending limit for the second user.

15. The system of claim 14, the operations further comprising:
responsive to receiving the indication of the second item to add to the virtual shopping cart, confirming that addition of the second item to the virtual shopping cart will not cause the second user to exceed the spending limit;
adding the second item to the virtual shopping cart responsive to confirming that addition of the second item to the virtual shopping cart will not cause the second user to exceed the spending limit.

16. The system of claim 14, the operations further comprising:
responsive to receiving the indication of the second item to add to the virtual shopping cart, determining that addition of the second item to the virtual shopping cart will exceed the spending limit for the second user;
rejecting addition of the second item to the virtual shopping cart responsive to determining that addition of the second item to the virtual shopping cart will exceed the spending limit for the second user.

17. A non-transitory computer-readable medium containing instructions that, when executed by one or more processors, cause the performance of operations comprising:
receiving, by at one or more computing devices and from a first computing device, identifying information for an account associated with a first user and identifying information for a second user, wherein the identifying information for the account associated with the second user is provided by the first user via a user interface of the first computing device;
transmitting, by the one or more computing devices and in response to receiving the identifying information for the second user, a notification to the second user indicating that the second user has been invited to join a shopping group initiated by the first user;
receiving, by the one or more computing devices and from a second computing device, a communication indicating acceptance, by the second user, of the invitation to join the shopping group initiated by the first user;
receiving, by the one or more computing devices, information indicating specific permissions for the second user with respect to the shopping group, the information indicating specific permissions for the second user having been provided by the first user;
associating an identifier for the second user with an electronic record for the shopping group;
associating at least one of the specific permissions with the identifier for the second user within the electronic record for the shopping group;
receiving, by the one or more computing devices and from the first computing device, an indication of a first item to add to a virtual shopping cart associated with the shopping group;
receiving, by the one or more computing devices and from the second computing device, an indication of a second item to add to the virtual shopping cart; and
transmitting information on an order placed in association with the virtual shopping cart for the shopping group to a computing device at a fulfillment location associated with a merchant.

18. The computer-readable medium of claim 17, wherein associating an identifier for the second user with the electronic record for the shopping group comprises:
using the identifying information for the second user provided by the first user to identify a profile for the second user, the profile being a profile associated with the merchant;
retrieving a unique identifier for the second user from the profile for the second user; and
entering the unique identifier for the second user into a group member field within the electronic record for the shopping group.

19. The computer-readable medium of claim 18, the operations further comprising:
receiving, from the first computing device, information indicating that the second user is permitted to pick up orders associated with the shopping group; and
in response to receiving the information indicating that the second user is permitted to pick up orders associated with the shopping group, associating a permission to pick up orders with the unique identifier for the second user within the electronic record for the shopping group.

20. The computer-readable medium of claim 17, the operations further comprising:
associating information for a first payment method provided by the first user with the shopping group;
associating information for a second payment method provided by the second user with the shopping group;
receiving an indication to split the payment for the order placed in association with the virtual shopping cart;
charging a first portion of the amount for the order to the first payment method; and
charging a second portion of the amount for the order to the second payment method.
